(19) United States
(12) Patent Application Publication
(10) Pub. No.: US 2024/0176317 A1
(43) Pub. Date: May 30, 2024

(54) METHOD AND SYSTEM FOR CONTROLLING AN INVERTER

(71) Applicant: MERIT SI, LLC, Somerville, NJ (US)

(72) Inventors: Dmitriy ANICHKOV, Somerville, NJ (US); Nick MILAM, Ottawa Hills, OH (US); Sachin SONI, Gilbert, AZ (US)

(21) Appl. No.: 18/518,132

(22) Filed: Nov. 22, 2023

Related U.S. Application Data
(60) Provisional application No. 63/428,938, filed on Nov. 30, 2022.

(51) Int. Cl. G05B 13/04; H02J 3/38

(52) U.S. Cl. CPC G05B 13/042; H02J 3/38; H02J 2300/20

(57) ABSTRACT

A method for controlling an inverter in an energy plant coupled to an electric power grid or operating in an islanded mode, the method comprising: using an inverter control system communicatively coupled to the inverter, receiving one or more command messages for controlling the inverter; determining whether a command message of the one or more command messages is legitimate by at least one of: comparing communications related parameters contained in the command message to predetermined legitimate communications related parameters; comparing value range related parameters contained in the command message to predetermined legitimate value ranges; comparing data received from the inverter with a predetermined functional model of the inverter; and, detecting power, current, or voltage oscillations at the inverter; if the command message is not legitimate, dropping the command message; and, if the command message is legitimate, generating one or more control signals to implement the command message and transmitting the one or more control signals to the inverter to control operation of the inverter.

This application claims priority from and the benefit of the filing date of U.S. Provisional Patent Application No. 63/428,938, filed Nov. 30, 2022, and the entire content of such application is incorporated herein by reference.

### FIELD OF THE APPLICATION

This application relates to the field of control systems, and more specifically, to a method and system for controlling an inverter, such as a grid-connected power inverter, and the like.

### BACKGROUND OF THE APPLICATION

The term “bulk-power system” generally refers to the following: facilities and control systems necessary for operating an interconnected electric energy transmission network (or any portion thereof); and, electric energy from generation facilities needed to maintain transmission reliability. For security reasons, bulk-power systems may be regulated by the government. For example, the Unites States government's Executive Order of May 1, 2020, prohibits the use of bulk-power system equipment produced by foreign adversaries (see “Executive Order on Securing the United States Bulk-Power System”; https://www.whitehouse.gov/presidential-actions/executive-order-securing-united-states-bulk-power-system/; accessed Aug. 23, 2020; and, incorporated herein by reference).

FIG. 1 is a block diagram illustrating an example PV power plant 100 in accordance with the prior r art. (See “WECC Solar Plant Dynamic Modeling Guidelines”; https://www.wecc.biz/Reliability/WECC %20Solar %20Plant %20Dynamic %20Modeling %20Gui delines.pdf; accessed Aug. 23, 2020; and, incorporated herein by reference.) Typical grid-connected inverter-based generation facilities include battery energy storage systems (“BESS”) and renewable energy plants such as photovoltaic (“PV”) plants and wind plants. The power plant 100 includes PV arrays 110 which supply DC power to inverters 120. AC current injected by the inverters 120 is stepped-up to medium voltage by PV inverter transformers 130 and transmitted by a medium voltage PV feeder 140. Further upstream, the medium voltage is stepped up by a substation transformer 150. The substation transformer 150 is connected via an interconnection line 160 to an electric energy transmission network (e.g., the bulk-power system, an electric power grid, etc.) 170 at a point-of-interconnection (“POI”) 175. Plant reactive compensation devices 180, if present, are connected at the plant medium voltage bus 190. The power plant control system, which is necessary to maintain grid reliability, includes inverter controls located inside the inverters 120, a PV plant supervisory control system 200, and other controls and relay protection devices omitted in FIG. 1 for clarity. The above-mentioned control devices typically communicate with each other using a power plant communication network. The PV plant supervisory control system 200 typically communicates with a plant fleet remote operations center 210 and a utility system operations center 220.

FIG. 2 is a block diagram illustrating an inverter battery storage control system 300 in accordance with the prior art. (See “WECC Battery Storage Dynamic Modeling Guideline”; https://www.wecc.biz/Reliability/WECC %20Battery %20Storage %20Guideline %20updates_%2 0B0%204-5-17%20SLT %204-7-17%20XX %20SC.docx; accessed Aug. 23, 2020; and, incorporated herein by reference.) The inverter control system 300 acts on active Pref and reactive Qext power references sent by the PV plant supervisory control system 200, with feedback of terminal voltage Vt, inverter power output Pgen, and inverter reactive output Qgen, and outputs real Ipcmd and reactive Iqcmd current commands.

One problem with such existing inverter control systems 300 is that they have limited computational resources to implement robust security mechanisms and data protection. In addition, these inverter control systems 300 often implement multiple communication technologies making it difficult to implement standard protection methods for them. This may cause such systems 300 to violate government regulations such as the Executive Order mentioned above.

Another problem with such existing inverter control systems 300 is that they may be manufactured in foreign countries as an integral part of the inverter 120. Being connected to the power plant's communications network, the inverter control system 300 may send malicious or illegitimate commands over the communication network to connected power plant relay protection systems, control systems (e.g., 200), and inverters 120, potentially causing loss of generation, stability-related events (e.g., frequency and voltage violations), safety-related events (e.g., anti-islanding), and failed protection. Because of the complexity of the inverter control system 300, even the system's comprehensive cyber security assessment methods may not be able to guarantee the security of the inverter control system 300. In addition, firmware updates to the inverter control system 300 are typically necessary to continue to comply with changing grid interconnection requirements and to address firmware discrepancies. These periodic firmware updates may further increase security risks.

A further problem with such existing inverter control systems 300 is that inverter 120 replacement may require grid interconnection model modification.

A need therefore exists for an improved method and system for controlling an inverter. Accordingly, a solution that addresses, at least in part, the above and other shortcomings is desired.

### SUMMARY OF THE APPLICATION

According to one aspect of the application, there is provided a method for controlling an inverter in an energy plant coupled to an electric power grid or operating in an islanded mode, the method comprising: using an inverter control system communicatively coupled to the inverter, receiving one or more command messages for controlling the inverter; determining whether a command message of the one or more command messages is legitimate by at least one of: comparing communications related parameters contained in the command message to predetermined legitimate communications related parameters; comparing value range related parameters contained in the command message to predetermined legitimate value ranges; comparing data received from the inverter with a predetermined functional model of the inverter; and, detecting power, current, or voltage oscillations at the inverter; if the command message is not legitimate, dropping the command message; and, if the command message is legitimate, generating one or more control signals to implement the command message and transmitting the one or more control signals to the inverter to control operation of the inverter.

In accordance with further aspects of the application, there is provided an apparatus such as an information system, a control system, a computer system, etc., a method for adapting these, as well as articles of manufacture such as a computer readable medium or product and computer program product or software product (e.g., comprising a non-transitory medium) having program instructions recorded thereon for practicing the method of the application.

### BRIEF DESCRIPTION OF THE DRAWINGS

Further features and advantages of the embodiments of the present application will become apparent from the following detailed description, taken in combination with the appended drawings, in which:

FIG. 1 is a block diagram illustrating an example PV power plant in accordance with the prior art;

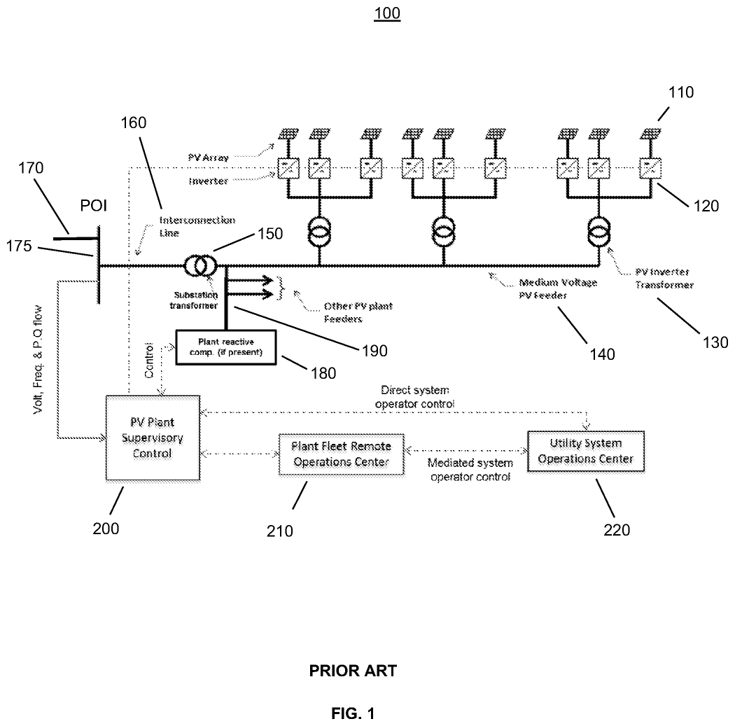

FIG. 2 is a block diagram illustrating an inverter battery storage control system in accordance with the prior art;

FIG. 3 is a block diagram illustrating an information system in accordance with an embodiment of the application;

FIG. 4 is a block diagram illustrating an inverter-based resource control system in accordance with an embodiment of the application;

FIG. 5 is a block diagram illustrating an inverter-based resource control system in accordance with another embodiment of the application;

FIG. 6 is a block diagram illustrating an inverter control system in accordance with an embodiment of the application;

FIG. 7 is a block diagram illustrating a first logic block of the inverter control system of FIG. 6 in accordance with an embodiment of the application;

FIG. 8 is a block diagram illustrating a second logic block of the inverter control system of FIG. 6 in accordance with an embodiment of the application; and,

FIG. 9 is a flow chart illustrating operations of modules within an information system for controlling an inverter in an energy plant coupled to an electric power grid or operating in an islanded mode, in accordance with an embodiment of the application.

It will be noted that throughout the appended drawings, like features are identified by like reference numerals.

### DETAILED DESCRIPTION OF THE EXAMPLE EMBODIMENTS

In the following description, details are set forth to provide an understanding of the application. In some instances, certain software, circuits, structures and methods have not been described or shown in detail in order not to obscure the application. The term “information system” or “system” is used herein to refer to any machine for processing data, including the control systems, controllers, energy management systems, supervisory control and data acquisition (“SCADA”) systems, computer systems, and network arrangements described herein. The present application may be implemented in any computer programming language provided that the operating system of the data processing system provides the facilities that may support the requirements of the present application. Any limitations presented would be a result of a particular type of operating system or computer programming language and would not be a limitation of the present application. The present application may also be implemented in hardware or in a combination of hardware and software.

According to one embodiment of the application, there is provided an improved method and system for controlling an inverter 2010. The provided method for controlling grid-connected power inverters 2010 with a controller (e.g., 2030) includes: receiving active and reactive power references; measuring voltage, active and reactive power at a point-of-measurement; modeling inverter terminal voltage; and, acting on the active and reactive power references, with feedback of terminal voltage, with the controller 2030 and communicating real and reactive current commands from the controller 2030 to the inverters 2010 over a communication link 2020.

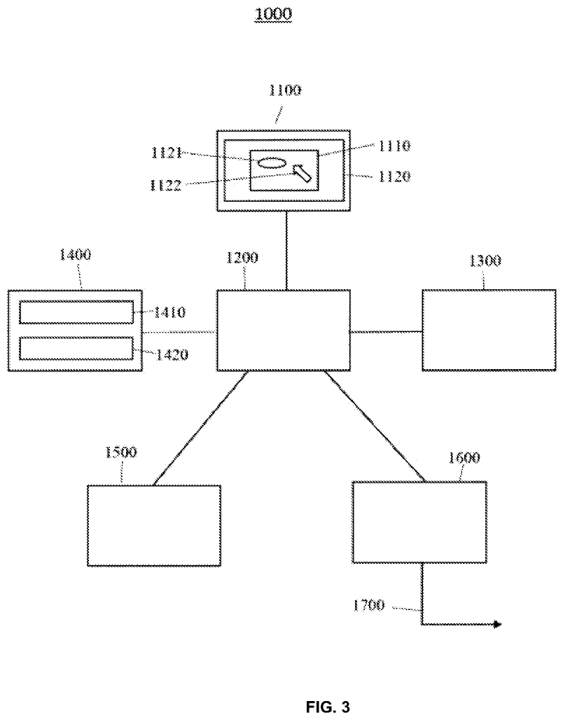

FIG. 3 is a block diagram illustrating an information system 1000 in accordance with an embodiment of the application. The information system 1000 is suitable for performing as a control system (e.g., 2030, 2050), controller, supervisory control and data acquisition (“SCADA”) system, energy management system (“EMS”), or the like. The information system 1000 may be implemented as a virtual machine. The information system 1000 may be a client and/or a server in a client-server configuration. As an example, the information system 1000 may be a server and/or a personal computer, microcontroller, etc. The information system 1000 may be a distributed system deployed on multiple processors or hosts.

The information system 1000 includes a display 1100, a processor or CPU 1200, an input device 1300, memory 1400, and an interface device 1600. The display 1100 may include a computer screen or a television screen. The CPU 1200 is coupled to memory 1400 that stores an operating system 1420 to manage the information system 1000. The CPU 1200 is operatively coupled to an input device 1300 for receiving user commands and to the display 1100 for displaying the results of these commands to a user. These commands may also be received over a network 1700 via the interface device 1600. The CPU 1200 may operate in association with dedicated co-processors, memory devices, or other hardware modules 1500. The input device 1300 may include a keyboard, mouse, touchpad, or the like. The memory 1400 may include a plurality of storage devices including internal memory and an external storage device. For example, the memory 1400 may include databases, random access memory, read-only memory, flash drives, solid state drives, and/or hard disk devices. The information system 1000 may include a database management system and a database 1410 that may be stored in the memory 1400 of the information system 1000. The interface device 1600 may include one or more network connections. The information system 1000 may be adapted to communicate with other information systems (e.g., 1000, 2030, 2050) over a network 1700 via the interface device 1600. For example, the interface device 1600 may include an interface to a network 1700 such as the Internet, a wireless network, a wired network (e.g., 2040), a serial communications network (e.g., 2020), etc. Thus, the interface 1600 may include suitable transmitters, receivers, connectors, and the like. The information system 1000 may be associated with other information systems (e.g., 1000, 2030, 2050) over the network 1700. Of course, the information system 1000 may include additional software and hardware, the description of which is not necessary for understanding the application.

The information system 1000 includes programmed computer-executable instructions to implement the embodiments of the present application. The instructions may be embodied in one or more hardware modules 1500 or program (software) modules (e.g., 1420) resident in the memory 1400 of the information system 1000. Alternatively, programmed instructions may be embodied on a machine-readable medium or product such as one or more DVDs, CDs, etc.

A user may interact with the information system 1000 using a user interface (“UI”) 1120 such as a graphical user interface. The UI 1120 may be used for monitoring, managing, and accessing the information system 1000. Typically, a UI is used to display information to and receive commands from users and includes a variety of controls including icons, drop-down menus, toolbars, text, buttons, and the like. A user interacts with the UI 1120 presented on a display 1100 by using an input device 1300 to position a pointer or cursor 1122 over a graphical object, for example, an icon, menu, etc. 1121 and by selecting the object 1121. Typically, UI elements are presented in at least one window 1110, that is, a rectangular area within the display 1100. A window 1110 may be open, closed, displayed full screen, reduced in size, or moved to different areas of the display 1100.

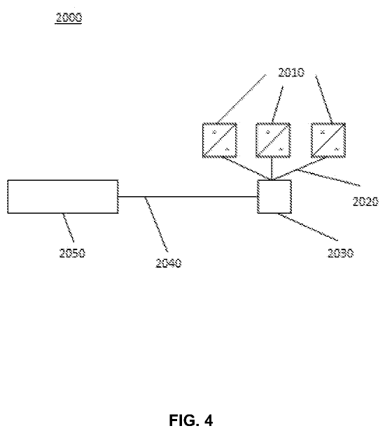

FIG. 4 is a block diagram illustrating an inverter-based resource control system 2000 in accordance with an embodiment of the application. The inverter-based resource control system 2000 may be used to control one or more inverter-based resources such as a photovoltaic system, wind power system, battery storage system, or their combination. The inverter-based resource control system 2000 may have one or more inverter control systems (or controllers) 2030. The inverter control system 2030 may communicate with a plant supervisory control system 2050 via a plant communication network 2040. The plant communication network 2040 may be a fiber optics or copper network that uses Ethernet, TCP/IP, or the like. The plant communication network 2040 may use communication protocols such as Modbus/TCP, DNP3, IEC 61131, or the like. In some cases, the plant supervisory control system 2050 may host or include the inverter control system 2030.

The inverter control system 2030 may be connected to one or more inverters 2010 by means of a communication network (or link) 2020 such as a serial communications network (e.g., RS-232, RS-422, RS-485, Controller Area Network (CAN bus), or the like).

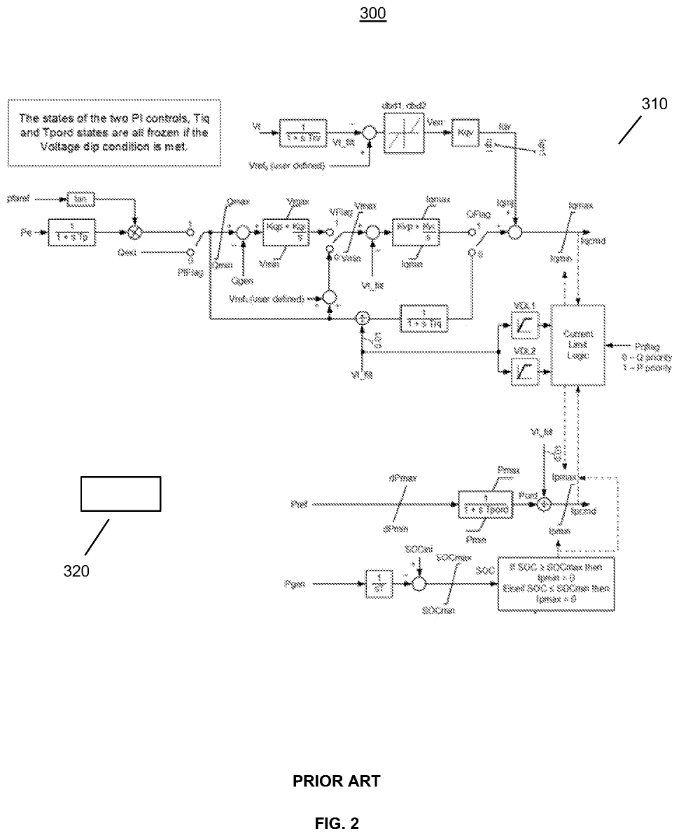

The inverter control system 2030 may implement inverter logic 310 such as that illustrated in FIG. 2 or any other logic necessary for operation of the inverters 2010. Some hardware-specific inverter logic may be executed in the inverter's field programmable gate arrays (“FPGA”) and or digital signal processors (“DSP”). FPGAs are semiconductor devices that are based around a matrix of configurable logic blocks while DSPs are specialized microprocessor chips that are optimized for the operational needs of digital signal processing.

According to one embodiment, a plant controller residing in the plant supervisory control system 2050 may communicate reactive power and active power commands Qext and Pref to the inverter control system 2030 using the MODBUS/TCP communication protocol over the power plant network 2040. The inverter control system 2030 may accept the commands Qext and Pref, process these commands through the inverter logic 310 illustrated in FIG. 2, for example, and communicate desired reactive and active current Iqcmd and Ipcmd commands to the inverter 2010 over a serial link 2020 using the MODBUS/RTU communication protocol.

The inverter control system (or controller) 2030 may detect a cyber-attack by analyzing command request frequency, communication protocol functional codes and other communication parameters, and command ranges. Incorrect, illegitimate, or malicious commands that are identified may be dropped (or rejected or ignored or denied) and reported.

The inverter control system 2030 may detect a cyber-attack or inverter malfunction by comparing acquired inverter data with an inverter functional model. The inverter functional model may reside in the control system 2030 or external to the control system 2030. In addition, the inverter control system 2030 may detect the cyber-attack or inverter malfunction by detecting power or voltage oscillations.

The inverter control system 2030 may respond to the cyber-attack by ramping down the inverters 2010, isolating the inverters' tripping switches and circuit breakers, and/or issuing corrective signals to the inverters 2010 to compensate for incorrect power levels, harmonics, or unbalanced currents and voltages.

According to one embodiment, the inverter control system 2030 may act as a client and may acquire data from and send commands to the inverters 2010 over the communication link 2020. The acquired inverter data may include terminal voltage, power output, reactive injection or absorption, or any other inverter data. The inverter commands may include active current, reactive current, or any other command required for inverter operation.

According to another embodiment, the inverter 2010 may act as a server and may reply to the data acquisition requests and process commands from the inverter control system 2030. The inverter control system 2030 prevents any unauthorized communications to or from the inverters 2010 thus protecting the inverters 2010, power plant control and relay protection devices, etc., from malicious or illegitimate behavior.

Unauthorized devices on the power plant network 2040 cannot directly communicate with the inverters 2010, thus decreasing the possible cyber-attack surface. The inverter control system 2030 may be configured to communicate on the network 2040 with explicitly specified devices (e.g., plant supervisory control system 2050), network communication ports, and protocols thus preventing any unauthorized devices from communicating with the inverter control system 2030. The inverter control system 2030 may use encryption for communications on the network 2040 so that the transmitted data is hidden from or inaccessible to unauthorized users.

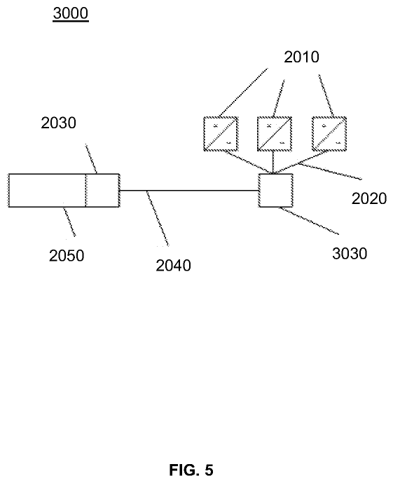

FIG. 5 is a block diagram illustrating an inverter-based resource control system 3000 in accordance with another embodiment of the application. In this embodiment, the plant supervisory control system 2050 includes or implements the inverter control system 2030. Similar to the system 2000 illustrated in FIG. 4, the inverter control system 2030 of FIG. 5 communicates with one or more inverters 2010 using the plant communication network 2040, an intervening protocol converter 3030, and the communication link 2020. The inverter logic 310 illustrated in FIG. 2, for example, may reside in the central inverter control system 2030 which may be hosted by the plant supervisory control system 2050.

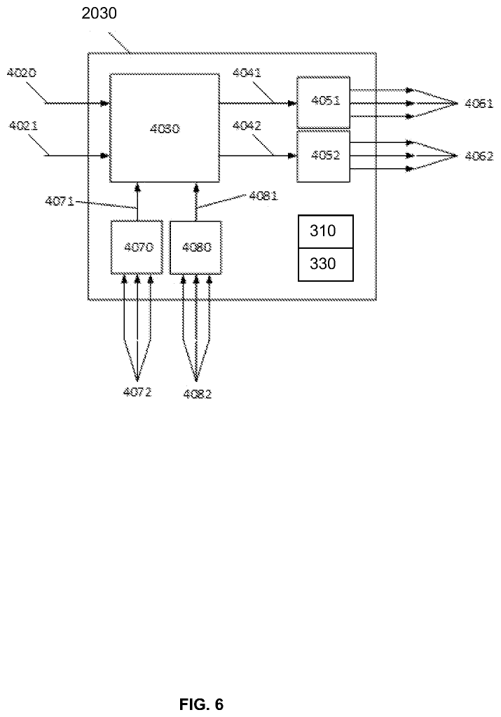

FIG. 6 is a block diagram illustrating an inverter control system 2030 in accordance with an embodiment of the application. As shown in FIG. 6, an inverter reactive power reference (or reference signal or reference level) 4020 and an inverter active power reference (or reference signal or reference level) 4021 communicated from (or receive from) a power plant controller are processed through a main logic block 4030. The main logic block 4030 outputs a desired reactive current (or current signal or current level) 4041 and a desired active current (or current signal or current level) 4042 to first and second logic blocks 4051 and 4052, respectively. The first logic block 4051 outputs the desired reactive currents 4061 to individual inverters 2010. The second block 4052 outputs the desired active currents 4062 also to individual inverters 2010. The desired currents 4061, 4062 are communicated to the inverters 2010 over communication links 2020.

A third logic block 4070 may acquire terminal voltages (or voltage signals or voltage levels) 4072 from the inverters 2010. The third logic block 4070 may process the acquired data calculating mean, median, or performing any other calculation and communicate the result 4071 representing the terminal voltage to the main logic block 4030. The third logic block 4070 may acquire voltages from power meters, instrumentation or relay protection devices located at low, medium, or high voltage buses of the resource. In this embodiment, the third block 4070 may use a model (e.g., a power flow model) to account for the difference between the point-of-metering and terminal voltage. The model may use line drop compensation or any other model type. In addition to the voltages, the model may acquire active and reactive currents and configuration parameters such as line drop compensation reactance and line drop compensation resistance.

A fourth logic block 4080 may acquire active and/or reactive power generation (or generation signals or generation levels) 4082 from the inverters 2010. The fourth logic block 4080 may process the acquired data calculating mean, median or performing any other calculation and communicate the result 4081 representing the power flow to the main logic block 4030. The fourth logic block 4080 may acquire power flow from power meters, instrumentation or relay protection devices located at the point-of-metering at low, medium, or high voltage feeders of the inverter-based resource. In this embodiment, the fourth block 4080 may use a model (e.g., a power flow model) to account for the difference between the point-of-metering and inverter power generation. The model may use line drop compensation or any other type of model. In addition to the power flow, the model may acquire voltages, power factors, configuration parameters such as line drop compensation reactance and line drop compensation resistance or any other parameters necessary for modeling.

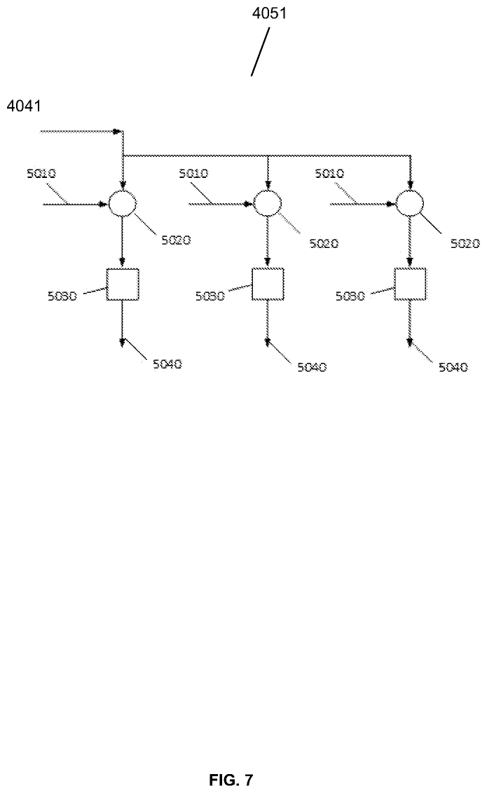

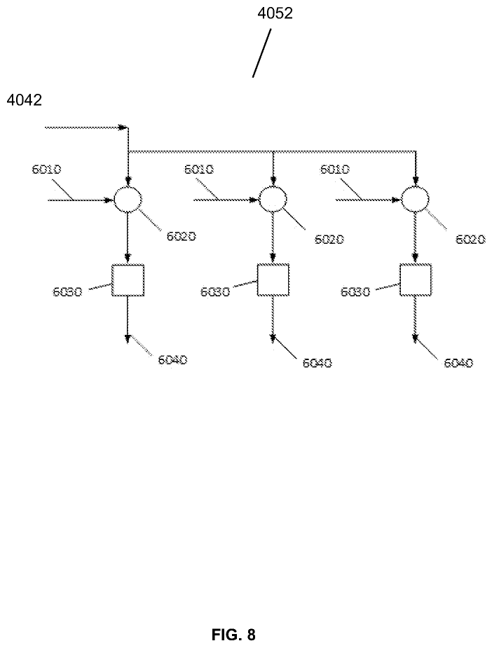

FIG. 7 is a block diagram illustrating a first logic block 4051 of the inverter control system 2030 of FIG. 6 in accordance with an embodiment of the application. As shown in FIG. 7, the input 4041 to the logic block 4051 is a desired reactive current that is summed with a reactive current additive coefficient 5010 of the first inverter, multiplied by a reactive current multiplicative coefficient 5030 of the first inverter, and sent as a desired inverter reactive current 5040 to the first inverter 2010. The logic block 4051 similarly generates and transmits commands 5040 to other inverters 2010 taking into account individual design and operating conditions of the other inverters 2010. The block 4051 may implement any other logic required, including arithmetic and logical operations, to account for the inverters' individual design and operating conditions. In one embodiment, outputs (or commands) Ipcmd, Iqcmd from the inverter control system 300 shown in FIG. 2 may be inputs 4041, 4042 to the first logic block 4051 of the inverter control system 2030 and the second logic block 4052 of the inverter control system 2030 shown in FIGS. 7 and 8, respectively.

FIG. 8 is a block diagram illustrating a second logic block 4052 of the inverter control system 2030 of FIG. 6 in accordance with an embodiment of the application. As shown in FIG. 8, the input 4042 to the logic block input 4052 is a desired active current that is summed with an active current additive coefficient 6010 of the first inverter, multiplied by a current multiplicative coefficient 6030 of the first inverter, and sent as a desired inverter active current 6040 to the first inverter 2010. The logic block 4052 similarly generates and transmits commands 6040 to other inverters 2010 taking into account individual design and operating conditions of the other inverters 2010. The block 4052 may implement any other logic required, including arithmetic and logical operations, to account for inverters' individual design and operating conditions. In one embodiment, outputs (or commands) Ipcmd, Iqcmd from the inverter control system 300 shown in FIG. 2 may be inputs 4041, 4042 to the first logic block 4051 of the inverter control system 2030 and the second logic block 4052 of the inverter control system 2030 shown in FIGS. 7 and 8, respectively.

In one embodiment, inverter logic 310 (see FIG. 2) is moved either partially or fully from multiple inverters 2010 to the controller 2030 which improves security and operations by replacing black box inverter logic (e.g., 320) with auditable controller logic (e.g., 330) written in, for example, the IEC 61131 graphical language. Moving ISO-specific logic (e.g., 330) to the controller 2030 makes remaining inverter logic (e.g., 310) more universal. This allows for inverter 2010 replacement with another OEM inverter without material modification of the plant model since ISO-specific logic 330 resides in the controller 2030 and also allows the controller 2030 to optimally distribute power and reactive commands among the connected inverters 2010 as shown in FIGS. 6-8. (Note that the acronym ISO stands for the “International Organization for Standardization”.)

The embodiments described herein may contribute to an improved method and system for controlling an inverter 2010 and may provide one or more advantages. First, the method and system reduce or prevent security threats by detecting and responding to cyber-attacks. Second, the method and system improve control security monitoring, detection and corrective actions such as: monitoring and validation of network commands; discarding and reporting nonvalid commands; detecting power and voltage oscillations; ramping down power output from the inverter 2010; operating circuit breakers or switches to isolate the inverter 2010 from the electric power grid 170; compensating for incorrect operating parameters of the inverter 210; sending commands in parallel to the inverter 2010 and on-line inverter model; and, comparing results and performing corrective actions.

Aspects of the methods and systems described herein may be illustrated with the aid of a flowchart.

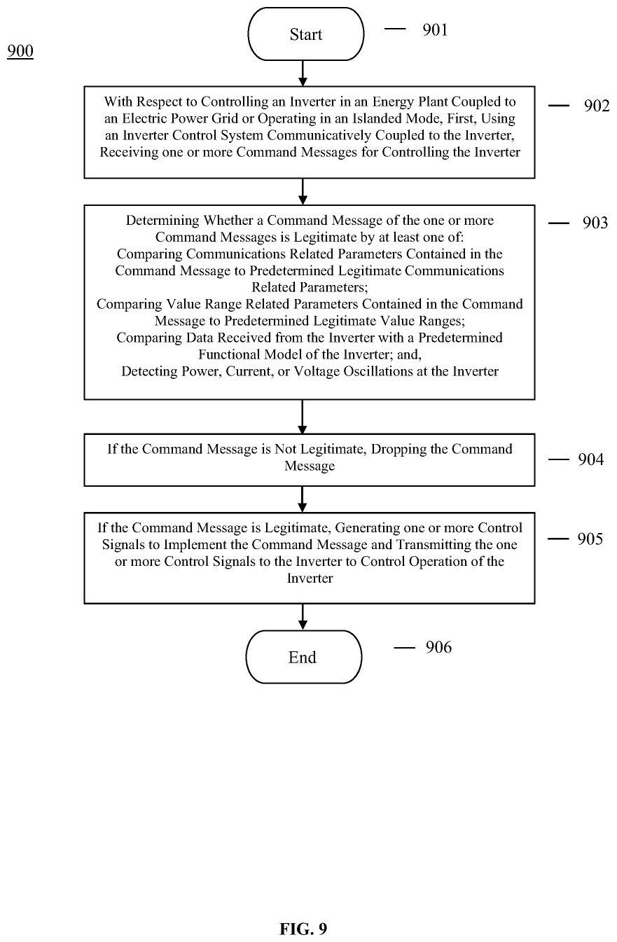

FIG. 9 is a flow chart illustrating operations 900 of modules (e.g., 1420, 1500) within an information system (e.g., 1000, 2030, 2050) for controlling an inverter 2010 in an energy plant 100 coupled to an electric power grid 170 or operating in an islanded mode, in accordance with an embodiment of the application.

At step 901, the operations 900 start.

At step 902, using an inverter control system 2030 communicatively coupled (e.g., 2020) to the inverter 2010, one or more command messages for controlling the inverter 2010 are received.

At step 903, whether a command message of the one or more command messages is legitimate is determined by at least one of: comparing communications related parameters contained in the command message to predetermined legitimate communications related parameters; comparing value range related parameters contained in the command message to predetermined legitimate value ranges; comparing data received from the inverter 2010 with a predetermined functional model of the inverter 2010; and, detecting power, current, or voltage oscillations at the inverter 2010.

At step 904, if the command message is not legitimate, the command message is dropped.

At step 905, if the command message is legitimate, one or more control signals are generated to implement the command message and the one or more control signals are transmitted (e.g., 2020) to the inverter 2010 to control operation of the inverter 2010.

At step 906, the operations 800 end.

The above method may further include, if the command message is not legitimate, that is, if oscillations are detected and/or data received from the inverter 2010 is different than the expected data from the predetermined functional model of the inverter 2010, transmitting one or more control signals to the inverter 2010 to at least one of: ramp down power output from the inverter 2010; operate a circuit breaker or switch to isolate the inverter 2010 from the electric power grid 170; and, compensate for incorrect operating parameters of the inverter 2010. The method may further include, if the command message is not legitimate, reporting that the command message is not legitimate to a plant supervisory control system 2050. The one or more command messages may be received from a plant supervisory control system 2050. The plant supervisory control system 2050 may be communicatively coupled to the inverter control system 2030 over a network 2040. The plant supervisory control system 2050 may include the inverter control system 2030. The communications related parameters may include one or more of command request frequency information and communication protocol functional codes. The predetermined functional model of the inverter 2010 may be stored at the inverter control system 2030. The predetermined functional model of the inverter 2010 may be stored at a plant supervisory control system 2050 communicatively coupled to the inverter 2010 control system over a network 2040. The energy plant 100 may be a renewable energy plant. The inverter 2010 may be coupled to an intermittent energy source 110. The inverter 2010 may include basic, universal, or non-black box controller logic (e.g., 310) and may not include ISO-specific controller logic (e.g., 330) thereby allowing for more rapid inverter replacement. And, the inverter control system 2030 may include ISO-specific controller logic (e.g., 330) thereby allowing for centralized maintenance of the ISO-specific controller logic (e.g., 330).

According to one embodiment, each of the above steps 901-906 may be implemented by a respective software module 1420. According to another embodiment, each of the above steps 901-906 may be implemented by a respective hardware module 1500 (e.g., application-specific hardware 1500). According to another embodiment, each of the above steps 901-906 may be implemented by a combination of software 1420 and hardware modules 1500. For example, FIG. 9 may represent a block diagram illustrating the interconnection of specific hardware modules 901-906 (collectively 1500) within the information system or systems 1000, each hardware module 901-906 adapted or configured to implement a respective step of the method of the application.

According to one embodiment, one or more of the software 1420 and hardware modules 1500 (or to components referred to as a “module” herein) may be implemented by one or more information systems 1000 or components thereof.

According to one embodiment, certain implementations of the functionality of the present application are sufficiently mathematically, computationally, or technically complex that application-specific hardware (e.g., 1500) or one or more physical computing devices (e.g., 1000, 2030, 2050) (using appropriate executable instructions (e.g., 1420)) may be necessary or essential to perform that functionality, for example, due to the volume or complexity of the calculations involved and/or to provide results substantially in real-time.

While this application is primarily discussed as a method, a person of ordinary skill in the art will understand that the apparatus discussed above with reference to an information system 1000 may be programmed to enable the practice of the method of the application. Moreover, an article of manufacture for use with an information system 1000, such as a pre-recorded storage device or other similar computer readable medium or computer program product including program instructions recorded thereon, may direct the information system 1000 to facilitate the practice of the method of the application. It is understood that such apparatus, products, and articles of manufacture also come within the scope of the application.

In particular, the sequences of instructions which when executed cause the method described herein to be performed by the information system 1000 may be contained in a data carrier product according to one embodiment of the application. This data carrier product may be loaded into and run by the information system 1000. In addition, the sequences of instructions which when executed cause the method described herein to be performed by the information system 1000 may be contained in a computer software product or computer program product (e.g., comprising a non-transitory medium) according to one embodiment of the application. This computer software product or computer program product may be loaded into and run by the information system 1000. Moreover, the sequences of instructions which when executed cause the method described herein to be performed by the information system 1000 may be contained in an integrated circuit product (e.g., a hardware module or modules 1420, 1500) which may include a coprocessor or memory according to one embodiment of the application. This integrated circuit product may be installed in the information system 1000.

The embodiments of the application described above are intended to be examples only. Those skilled in the art will understand that various modifications of detail may be made to these embodiments, all of which come within the scope of the application.

What is claimed is:

1. A method for controlling an inverter in an energy plant coupled to an electric power grid or operating in an islanded mode, the method comprising:
using an inverter control system communicatively coupled to the inverter, receiving one or more command messages for controlling the inverter;
determining whether a command message of the one or more command messages is legitimate by at least one of:
comparing communications related parameters contained in the command message to predetermined legitimate communications related parameters;
comparing value range related parameters contained in the command message to predetermined legitimate value ranges;
comparing data received from the inverter with a predetermined functional model of the inverter; and,
detecting power, current, or voltage oscillations at the inverter;
if the command message is not legitimate, dropping the command message; and,
if the command message is legitimate, generating one or more control signals to implement the command message and transmitting the one or more control signals to the inverter to control operation of the inverter.

2. The method of claim 1, further comprising, if the command message is not legitimate, that is, if oscillations are detected and/or data received from the inverter is different than the expected data from the predetermined functional model of the inverter, transmitting one or more control signals to the inverter to at least one of: ramp down power output from the inverter; operate a circuit breaker or switch to isolate the inverter from the electric power grid; and, compensate for incorrect operating parameters of the inverter.

3. The method of claim 1, further comprising, if the command message is not legitimate, reporting that the command message is not legitimate to a plant supervisory control system.

4. The method of claim 1, wherein the one or more command messages are received from a plant supervisory control system.

5. The method of claim 4, wherein the plant supervisory control system is communicatively coupled to the inverter control system over a network.

6. The method of claim 4, wherein the plant supervisory control system includes the inverter control system.

7. The method of claim 1, wherein the communications related parameters include one or more of command request frequency information and communication protocol functional codes.

8. The method of claim 1, wherein the predetermined functional model of the inverter is stored at the inverter control system.

9. The method of claim 1, wherein the predetermined functional model of the inverter is stored at a plant supervisory control system communicatively coupled to the inverter control system over a network.

10. The method of claim 1, wherein the energy plant is a renewable energy plant.

11. The method of claim 1, wherein the inverter is coupled to an intermittent energy source.

12. The method of claim 1, wherein the inverter includes basic, universal, or non-black box controller logic and does not include ISO-specific controller logic thereby allowing for more rapid inverter replacement.

13. The method of claim 12, wherein the inverter control system includes ISO-specific controller logic thereby allowing for centralized maintenance of the ISO-specific controller logic.

14. A control system for an inverter in an energy plant coupled to an electric power grid, the control system comprising:
a processor coupled to memory and an interface to a network; and,
at least one of hardware and software modules within the memory and controlled or executed by the processor, the modules including computer readable instructions executable by the processor for causing the control system to implement the method of claim 1.
